(19) United States
(12) Patent Application Publication
(10) Pub. No.: US 2019/0035337 A1
(43) Pub. Date: Jan. 31, 2019

(54) DISPLAY PANEL, CONTROL DEVICE FOR DISPLAY PANEL, DISPLAY DEVICE, AND METHOD FOR DRIVING DISPLAY PANEL

(71) Applicant: JOLED INC., Tokyo (JP)

(72) Inventor: Toshiyuki KATO, Tokyo (JP)

(73) Assignee: JOLED INC., Tokyo (JP)

(21) Appl. No.: 16/009,770

(22) Filed: Jun. 15, 2018

(30) Foreign Application Priority Data
Jul. 28, 2017 (JP) 2017-146282

(51) Int. Cl. G09G 3/3266; G09G 3/3275

(52) U.S. Cl. CPC G09G 3/3266; G09G 3/3275; G09G 2310/063; G09G 2320/10; G09G 2320/0247; G09G 2320/0266; G09G 2310/0286

(57) ABSTRACT

A display panel includes: a panel unit including a plurality of pixel circuits arranged in rows and columns; a source driving circuit that supplies, to the pixel circuits, a video image signal representing a video image displayed on the panel unit; a gate driving circuit that supplies, to the pixel circuits in a row-sequential manner, control signals each being a gate signal indicating a write timing of writing the video image signal; and a control terminal that receives a clear signal that serves as a refresh interruption signal. When the clear signal is received by the control terminal during the supply of the control signals, the gate driving circuit interrupts the supply of the control signals to the pixel circuits in a subsequent row.

The present application is based on and claims priority of Japanese Patent Application No. 2017-146282 filed on Jul. 28, 2017. The entire disclosure of the above-identified application, including the specification, drawings and claims is incorporated herein by reference in its entirety.

### FIELD

The present disclosure relates to a display panel, a control device for a display panel, a display device, and a method for driving a display panel.

### BACKGROUND

In computers and mobile devices, a video image displayed on a display panel is generated by a video image processing device called graphics processing unit (GPU). The video image generated by the GPU includes a plurality of frame images, each frame image including luminance data per pixel. A data signal corresponding to the luminance data per pixel is written into a plurality of pixel circuits being arranged in rows and columns on the display panel in a row-sequential manner (so-called refresh operation), and the frame images are displayed on the display panel.

There is a display panel in which a data signal is written into the pixel circuits at a fixed refresh rate. Such a display panel is designed such that a new frame image is ready for use every refresh cycle. However, the time required by the GPU to generate one frame image varies widely depending on the GPU's processing power and the content of the image. For this reason, in fact, a new frame image may not be ready for use in time before a subsequent refresh cycle starts, but may be ready for use during the refresh cycle.

In the case where the refresh rate is fixed, when a frame image becomes ready for use during a refresh cycle, a portion of the frame image that corresponds to the remaining portion of the refresh cycle is immediately written into the pixel circuits, or the display panel waits until the next refresh cycle, and the entire frame image is written into the pixel circuits sequentially from the first pixel circuit.

With the former method, a video image lag is unlikely to occur. However, an image interference called tearing occurs that is phenomenon in which a preceding frame image is displayed on a portion of a screen, and a new frame image is displayed in the remaining portion of the screen. Also, with the latter method, although tearing does not occur, an unsmooth motion called stuttering occurs.

To address this, a video image display technique is proposed in which the refresh rate is not fixed so that a refresh starts immediately when a new frame image becomes ready for use, so as to eliminate tearing and stuttering (see, for example, Non Patent Literature (NPL) 1). NPL 1 discloses, in the implementation overview section, that in the case where the refresh rate is low, a vertical blank period that is longer than the vertical blank period at a normal refresh rate is provided after an active frame that has the same length as the active frame at the normal refresh rate.

### CITATION LIST

### Patent Literature

### Non Patent Literature

White Paper|AMD PROJECT FREESYNC, MARCH 2014, AMD RADEON GRAPHICS, retrieved on Jul. 11, 2017 from the Internet (URL: http://www.amd.com/Documents/FreeSync-Whitepaper.pdf)

### SUMMARY

### Technical Problem

With conventional video image display techniques, there is a concern that if it takes a long time to generate a new frame image, degradation in grayscale representation and flickering may occur.

To address this, it is an object of the present disclosure to provide a display panel, a control device for a display panel, a display device, and a method for driving a display panel, with which it is possible to avoid video image tearing and stuttering, as well as suppressing degradation in grayscale representation and flickering.

### Solution to Problem

In order to achieve the object described above, a display panel according to one aspect of the present disclosure includes: a panel unit including a plurality of pixel circuits arranged in rows and columns; a source driving circuit that supplies, to the pixel circuits, a video image signal representing a video image displayed on the panel unit; a gate driving circuit that supplies a gate signal to the pixel circuits in a row-sequential manner, the gate signal indicating a write timing of writing the video image signal; and a control terminal that receives a refresh interruption signal. When the refresh interruption signal is received by the control terminal during the supply of the gate signal, the gate driving circuit interrupts the supply of the gate signal to the pixel circuits in a subsequent row.

With this configuration, the supply of the gate signal that controls a write operation (so-called refresh) of writing a video image signal into the pixel circuits in a row-sequential manner can be interrupted during one frame image.

For this reason, when displaying a video image composed of a plurality of frame images having a variable frame rate, a refresh is repeatedly performed in the preceding frame image until the subsequent frame image is ready for use. When the subsequent frame image is ready for use, the refresh in the preceding frame image is immediately interrupted. Accordingly, it is possible to start a refresh in the subsequent frame image from the first row. Because a long vertical blank period is not provided to wait for the subsequent frame image, video image signal volatilization does not occur within the pixel circuits.

As a result, it is possible to obtain a display panel, with which it is possible to avoid video image tearing and stuttering, as well as suppressing degradation in grayscale representation and flickering caused by video image signal volatilization within the pixel circuits.

Also, the gate driving circuit may include: a clear terminal that receives a clear signal that functions as the refresh interruption signal; a start terminal that receives a start signal; and a shift register in which a plurality of registers provided corresponding to the rows of the panel unit are connected in multiple stages. A first-stage register may acquire the start signal from the start terminal. The shift register may output the start signal as a per-row gate signal while transferring the start signal between the registers. The start signal in second and subsequent-stage registers may be cleared according to the clear signal.

With this configuration, interruption of a refresh in the preceding frame image and start of a refresh in the subsequent frame image can be controlled by using a clear signal and a start signal that are independent of each other. Accordingly, the above-described advantageous effects can be achieved by a more highly versatile and flexible configuration.

Also, the gate driving circuit may include: a start terminal that receives a start signal that functions as the refresh interruption signal; and a shift register in which a plurality of registers provided corresponding to the rows of the panel unit are connected in multiple stages. A first-stage register may acquire the start signal from the start terminal. The shift register may output a per-row gate signal while transferring the start signal between the registers. The start signal in second and subsequent-stage registers may be cleared according to a new start signal acquired by the first-stage register.

With this configuration, interruption of a refresh in the preceding frame image and start of a refresh in the subsequent frame image can be controlled by using a single start signal. Accordingly, the above-described advantageous effects can be achieved by using a less number of control signals.

Also, a control device for a display panel according to one aspect of the present disclosure is a control device for a display panel including: a display panel and a control device. The display panel includes: a plurality of pixel circuits that are arranged in rows and columns; a source driving circuit that supplies a video image signal to the pixel circuits; and a gate driving circuit that supplies a gate signal indicating a write timing of writing the video image signal to the pixel circuits in a row-sequential manner, and interrupts the supply of the gate signal to the pixel circuits in a subsequent row according to a refresh interruption signal provided during the supply of the gate signal. The control device includes: a video image signal supply unit that receives a video image signal representing a video image including a plurality of frame images having a variable frame rate, and supplies the video image signal to the display panel; and a scanning control unit that supplies the refresh interruption signal to the display panel when starting supply of the video image signal that corresponds to a new frame image.

With this configuration, the supply of the gate signal that controls a write operation (so-called refresh) of writing a video image signal into the pixel circuits in a row-sequential manner can be interrupted during one frame image.

For this reason, when displaying a video image composed of a plurality of frame images having a variable frame rate, a refresh is repeatedly performed in the preceding frame image until the subsequent frame image is ready for use. When the subsequent frame image is ready for use, the refresh in the preceding frame image is immediately interrupted. Accordingly, it is possible to start a refresh in the subsequent frame image from the first row. Because a long vertical blank period is not provided to wait for the subsequent frame image, video image signal volatilization does not occur within the pixel circuits.

As a result, it is possible to obtain a control device for a display panel, with which it is possible to avoid video image tearing and stuttering, as well as suppressing degradation in grayscale representation and flickering caused by video image signal volatilization within the pixel circuits.

Also, a display device according to one aspect of the present disclosure is a display device including: a display panel and a control device. The display panel includes: a panel unit including a plurality of pixel circuits arranged in rows and columns; a source driving circuit that supplies, to the pixel circuits, a video image signal representing a video image displayed on the panel unit; a gate driving circuit that supplies a gate signal to the pixel circuits in a row-sequential manner, the gate signal indicating a write timing of writing the video image signal; and a control terminal that receives a refresh interruption signal. When the refresh interruption signal is received by the control terminal during the supply of the gate signal, the gate driving circuit interrupts the supply of the gate signal to the pixel circuits in a subsequent row. The control device includes: a video image signal supply unit that receives a video image signal representing a video image including a plurality of frame images having a variable frame rate, and supplies the video image signal to the display panel; and a scanning control unit that supplies the refresh interruption signal to the display panel when starting supply of the video image signal that corresponds to a new frame image.

With this configuration, the supply of the gate signal that controls a write operation (so-called refresh) of writing a video image signal into the pixel circuits in a row-sequential manner can be interrupted during one frame image.

For this reason, when displaying a video image composed of a plurality of frame images having a variable frame rate, a refresh is repeatedly performed in the preceding frame image until the subsequent frame image is ready for use. When the subsequent frame image is ready for use, the refresh in the preceding frame image is immediately interrupted. Accordingly, it is possible to start a refresh in the subsequent frame image from the first row. Because a long vertical blank period is not provided to wait for the subsequent frame image, video image signal volatilization does not occur within the pixel circuits.

As a result, it is possible to obtain a display device, with which it is possible to avoid video image tearing and stuttering, as well as suppressing degradation in grayscale representation and flickering caused by video image signal volatilization within the pixel circuits.

Also, a method for driving a display panel according to one aspect of the present disclosure includes: supplying a gate signal to a plurality of pixel circuits that are arranged in rows and columns, the gate signal indicating a write timing of writing the video image signal; receiving a refresh interruption signal during the supplying of the gate signal; and interrupting the supplying of the gate signal to the pixel circuits in a subsequent row when the refresh interruption signal is received.

With this configuration, the supply of the gate signal that controls a write operation (so-called refresh) of writing a video image signal into the pixel circuits in a row-sequential manner can be interrupted during one frame image.

For this reason, when displaying a video image composed of a plurality of frame images having a variable frame rate, a refresh is repeatedly performed in the preceding frame image until the subsequent frame image is ready for use. When the subsequent frame image is ready for use, the refresh in the preceding frame image is immediately interrupted. Accordingly, it is possible to start a refresh in the subsequent frame image from the first row. Because a long vertical blank period is not provided to wait for the subsequent frame image, video image signal volatilization does not occur within the pixel circuits.

As a result, it is possible to obtain a method for driving a display panel, with which it is possible to avoid video image tearing and stuttering, as well as suppressing degradation in grayscale representation and flickering caused by video image signal volatilization within the pixel circuits.

### Advantageous Effects

With the display panel, the control device for a display panel, the display device, and the method for driving a display panel according to the present disclosure, it is possible to avoid video image tearing and stuttering, as well as suppressing degradation in grayscale representation and flickering caused by video image signal volatilization within the pixel circuits.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a schematic diagram showing an example of a configuration of a display device according to an embodiment.

FIG. 2 is a circuit diagram showing an example of a configuration of a pixel circuit according to the embodiment.

FIG. 3 is a block diagram showing an example of a configuration of the display device according to the embodiment.

FIG. 4 is a circuit diagram showing an example of a configuration of a gate driving circuit according to the embodiment.

FIG. 5 is a timing chart illustrating examples of operations performed in the display device according to the embodiment.

FIG. 6 is a timing chart illustrating the advantageous effects of the display device according to the embodiment.

FIG. 7 is a block diagram showing an example of a configuration of another display device according to the embodiment.

FIG. 8 is a circuit diagram showing an example of a configuration of another gate driving circuit according to the embodiment.

FIG. 9 is a timing chart illustrating examples of operations performed in the another display device according to the embodiment.

FIG. 10 is a circuit diagram showing an example of configuration of a pixel circuit according to a variation.

FIG. 11 is a circuit diagram showing an example of a configuration of a pixel circuit according to a variation.

FIG. 12 is a circuit diagram showing an example of a configuration of a pixel circuit according to a variation.

FIG. 13 is an external view of a thin flat television system that is an example of a display device in which a control device according to an embodiment is incorporated.

### DESCRIPTION OF EMBODIMENT

Hereinafter, embodiments according to the present disclosure will be described. The embodiments described below show generic and specific examples of the present disclosure. Accordingly, the numerical values, shapes, materials, structural elements, the arrangement and connection of the structural elements, and the like shown in the following embodiments are merely examples, and therefore are not intended to limit the scope of the present disclosure. Thus, among the structural elements described in the following embodiments, structural elements not recited in any one of the independent claims are described as arbitrary structural elements.

In addition, the diagrams are schematic representations, and thus are not necessarily true to scale. In the diagrams, structural elements that are substantially the same are given the same reference numerals, and a redundant description is omitted or simplified.

### Embodiments

Hereinafter, an embodiment will be described. The present embodiment will be described by taking a display device 1 that uses organic electroluminescent (EL) elements as an example of the display device according to the present disclosure.

### 1. Configuration of Display Device

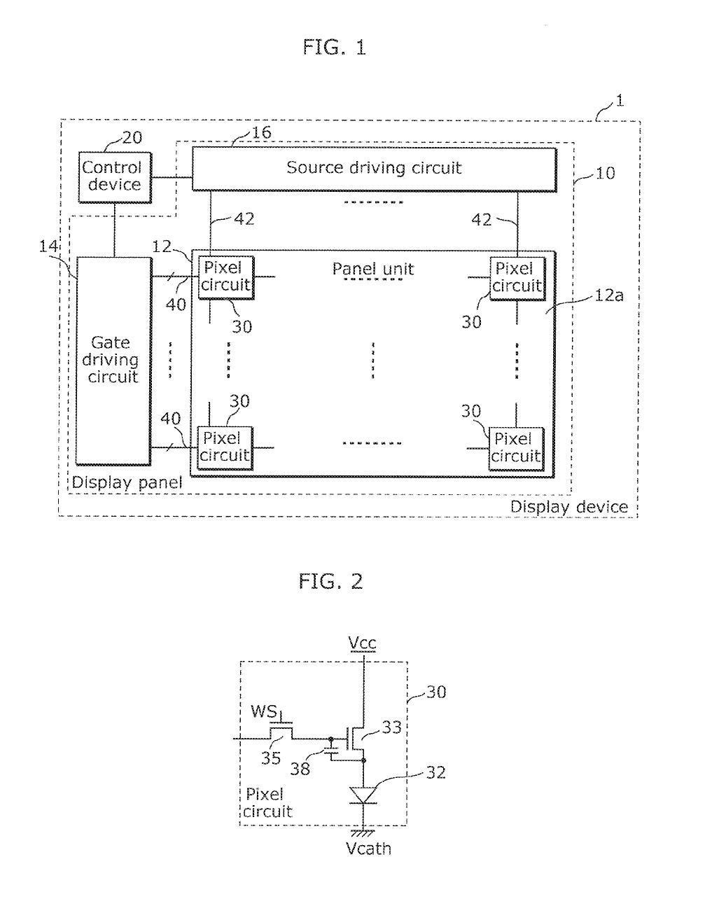

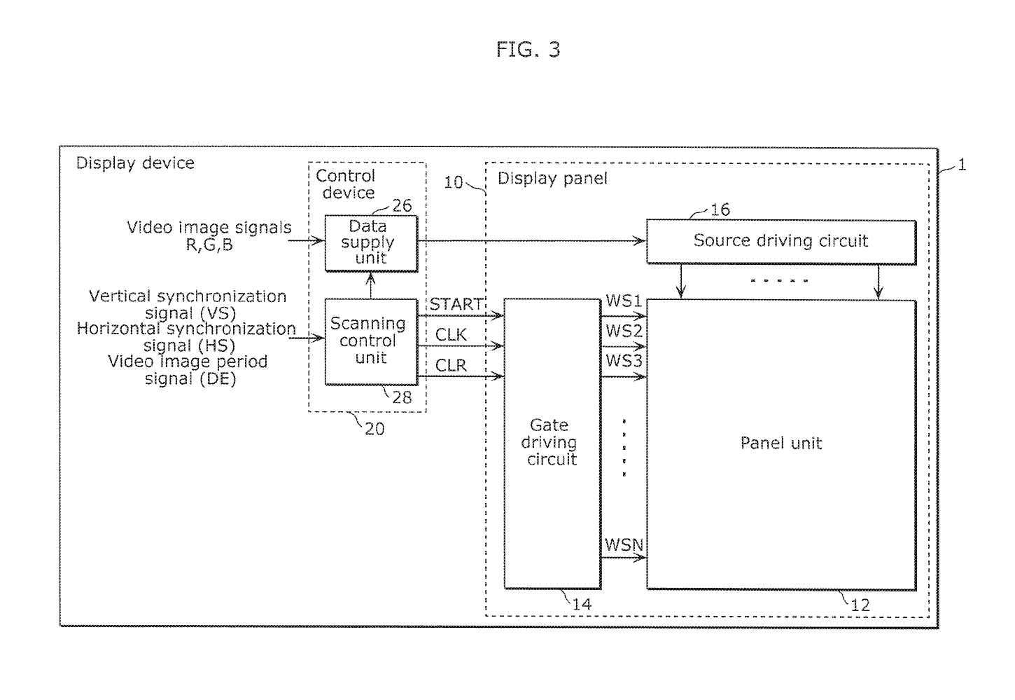

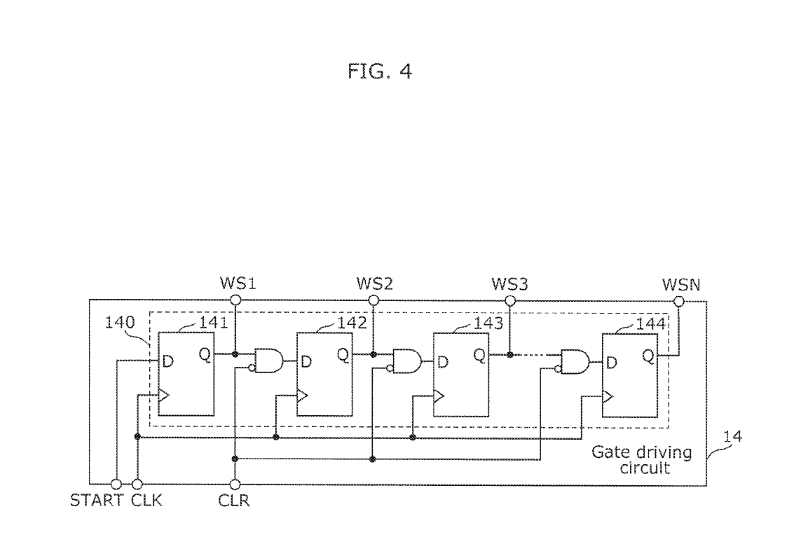

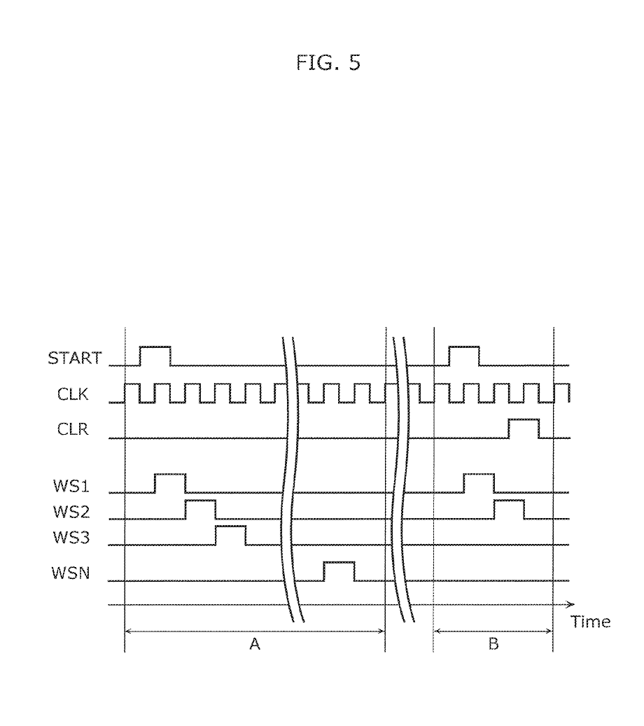

First, a configuration of the display device 1 will be described. FIG. 1 is a schematic diagram showing an example of a configuration of the display device 1 according to the present embodiment. FIG. 2 is a circuit diagram showing an example of a configuration of a pixel circuit 30 according to the present embodiment. FIG. 3 is a block diagram showing an example of a configuration of the display device 1 according to the present embodiment. FIG. 4 is a circuit diagram showing an example of a configuration of a gate driving circuit 14 according to the present embodiment.

As shown in FIG. 1, the display device 1 includes a display panel 10 and a control device 20. The display panel 10 includes a panel unit 12, a gate driving circuit 14, a source driving circuit 16, scanning lines 40, and signal lines 42. The panel unit 12, the gate driving circuit 14, the source driving circuit 16, the scanning lines 40, and the signal lines 42 are mounted on, for example, a panel substrate 12a.

The panel unit 12 includes a panel substrate 12a that was mentioned above, a plurality of pixel circuits 30 that are arranged in rows and columns on the panel substrate 12a, and scanning lines 40 and signal lines 42 that were also mentioned above. To be more specific, the panel unit 12 includes scanning lines 40 arranged in rows, signal lines 42 arranged in columns, and pixel circuits 30 each including a light emitting element 32 and being disposed at a portion where a scanning line and a signal line intersect. The panel substrate 12a is made of, for example, glass or a resin such as acrylic resin.

The plurality of pixel circuits 30 are formed on the panel substrate 12a by, for example, a semiconductor process. The plurality of pixel circuits 30 are arranged in, for example, N rows and M columns. The values N and M vary depending on the size and resolution of the display screen. For example, in the case where pixel circuits 30 corresponding to three primary colors of R, G, and B are provided side by side in a row at a resolution called a high definition (HD), N represents at least 1080 rows, and M represents at least 1920×3 columns. Each pixel circuit 30 includes an organic EL element as the light emitting element, and constitutes any one of the light emitting pixels of three primary colors of R, G, and B.

As shown in FIG. 2, a pixel circuit 30 includes a light emitting element 32, a driving transistor 33, a selection transistor 35, and a pixel capacitor 38. A configuration and operations of the pixel circuit 30 will be described later in detail.

A scanning line 40 is provided for each row of the plurality of pixel circuits 30 that are arranged in rows and columns. One end of the scanning line 40 is connected to the output terminal of a corresponding stage of the gate driving circuit 14.

A signal line 42 is provided for each column of the plurality of pixel circuits 30 that are arranged in rows and columns. One end of the signal line 42 is connected to the output terminal of a corresponding stage of the source driving circuit 16.

The gate driving circuit 14 is a driving circuit that is also called “row driving circuit” and that scans a gate driving signal per row of pixel circuits 30. The gate driving signal is a signal that is input into the gates of the driving transistor 33 and the selection transistor 35 of each pixel circuit 30 so as to perform control to turn each transistor on and off. The gate driving circuit 14 outputs, for example, a control signal WS as a signal for controlling the selection transistor 35. Also, as shown in FIG. 1, the gate driving circuit 14 is provided on one of the short sides of the panel unit 12.

The gate driving circuit 14 includes, for example, a shift register, or the like. In response to a control signal provided from the control device 20, the gate driving circuit 14 outputs a gate driving signal, and drives the scanning lines 40. As a result, pixel circuits 30 are line sequentially selected for each frame, and the light emitting elements 32 of the pixel circuits 30 emit light at a luminance according to the video image signal.

As shown in FIG. 1, the gate driving circuit 14 may be provided on one of the short sides of the panel unit 12, or may be provided on each of the opposing short sides of the panel unit 12. As a result of the gate driving circuit 14 being provided on each of the opposing short sides of the panel unit 12, it is possible to supply the same gate driving signal to the plurality of pixel circuits 30 that are disposed on the panel unit 12 at the same timing. Accordingly, for example, if the panel unit 12 is large-sized, it is possible to suppress a signal degradation caused by the interconnect capacitance of the scanning lines 40.

The source driving circuit 16 is a driving circuit that is also called “column driving circuit” and that supplies a video image signal that is supplied per frame from the control device 20 to each pixel circuit 30. The source driving circuit 16 is provided on one of the long sides of the panel unit 12.

The source driving circuit 16 is a current writing type or voltage writing type driving circuit that writes luminance information based on the video image signal into each pixel circuit 30 in the form of a current value or a voltage value through the signal lines 42. As the source driving circuit 16 according to the present embodiment, for example, a voltage writing type driving circuit is used. The source driving circuit 16 supplies a voltage that represents the brightness of the light emitting element 32 provided in each pixel circuit 30 to the signal lines 42 based on the video image signal input from the control device 20.

The video image signal input from the control device 20 to the source driving circuit 16 includes, for example, digital serial data of each of three primary colors of R, G, and B (video image signals R, G, and B). The video image signals R, G, and B input to the source driving circuit 16 are converted to parallel data per row within the source driving circuit 16. Furthermore, the parallel data per row is converted to analog data per row within the source driving circuit 16, which is then output to the corresponding signal line 42. The voltage output to the signal line 42 is written into the pixel capacitors 38 of the pixel circuits 30 that belong to the row selected through scanning performed by the gate driving circuit 14. That is, an electric charge corresponding to the voltage output to the signal line 42 is accumulated in the pixel capacitors 38.

As shown in FIG. 1, the source driving circuit 16 may be provided on one of the long sides of the panel unit 12, or may be provided on each of the opposing long sides of the panel unit 12. With this configuration, for example, if the panel unit 12 is large-sized, it is possible to output voltage to the pixel circuits 30 of the same column at the same timing.

### 2. Configuration of Pixel Circuit

As shown in FIG. 2, a pixel circuit 30 includes a light emitting element 32, a driving transistor 33, a selection transistor 35, and a pixel capacitor 38.

The light emitting element 32 is, for example, a diode-type organic EL element that includes an anode and a cathode. The light emitting element 32 is not limited to an organic EL element, and may be any other light emitting element. For example, the light emitting element 32 can be any ordinary element that is current-driven and emits light.

The light emitting element 32 includes; for example, a plurality of first electrode layers that are made of transparent conductive films; an organic layer in which a positive hole transport layer, a light emission layer, an electron transport layer, and an electron injection layer are deposited in this order on the first electrode layers; and a second electrode layer that is made of a metal film and is provided on the organic layer. In FIG. 2, the light emitting element 32 is schematically indicated by a symbol. When a direct current voltage is applied between the first electrode layers and the second electrode layer of the light emitting element 32, recombination of electrons and positive holes takes place in the light emission layer. As a result, due to the drain-to-source current of the driving transistor 33 supplied from the driving transistor 33, the light emitting element 32 emits light at a luminance according to the signal potential of the video image signal.

The driving transistor 33 is an active element that drives the light emitting element 32 to emit light. The driving transistor 33 supplies the drain-to-source current that corresponds to the gate-to-source voltage to the light emitting element 32 by being turned on.

The selection transistor 35 is turned on according to the control signal WS supplied from the scanning line 40, and an electric charge corresponding to the signal potential of the video image signal supplied from the signal line 42 is accumulated in the pixel capacitor 38.

The pixel capacitor 38 applies a voltage to the gate of the driving transistor 33 according to the signal potential based on the accumulated electric charge.

The driving transistor 33 and the selection transistor 35 are, for example, N channel type polysilicon TFTs (Thin Film Transistors). The conductivity type of the transistors is not limited to the above, and N channel type and P channel type TFTs may be mixed as appropriate. Also, the transistors are not limited to polysilicon TFTs, and may be amorphous silicon TFTs, or the like.

Operations performed by the pixel circuits 30 will now be described. Immediately before a new frame period starts, the control signal WS is at a low level. In this state, the selection transistors 35 that are N channel type transistors are off.

Each driving transistor 33 supplies the drain-to-source current to the light emitting element 32 according to the gate-to-source voltage of the driving transistor 33 that corresponds to the signal potential of the video image signal written into the pixel capacitor 38 during the preceding frame period. At this time, the light emitting element 32 emits light at a luminance of the preceding frame.

In a new frame period, the control signal WS is set from the low level to a high level in a row-sequential manner. In the pixel circuits 30 in a row at which the control signal WS is set to a high level, the potential signal of the video image signal is written into the pixel capacitors 38 (the refresh operation described above). Through this, the luminance of light emitted by the light emitting elements 32 is switched from the luminance of the preceding frame to the luminance of the new frame in a row-sequential manner.

By repeating the operations described above for each frame, the light emitting elements 32 that are arranged in rows and columns sequentially emit light according to the signal potential of the video image signal, and a video image is displayed on the panel unit 12.

### 3. Configurations of Control Device and Gate Driving Circuit

Next, the configurations of the control device 20 and the gate driving circuit 14 will be described.

The control device 20 is formed on an external system circuit substrate (not shown) provided outside the display panel 10. The control device 20 functions as, for example, a TCON (Timing Controller), and controls the overall operations of the display device 1. To be specific, the control device 20 provides an instruction to perform scanning to the gate driving circuit 14 according to a vertical synchronization signal VS, a horizontal synchronization signal HS, and a video image period signal DE that are supplied from an external apparatus such as an image processing apparatus (GPU). Also, the control device 20 supplies digital serial data of video image signals R, G, and B to the source driving circuit 16.

As shown in FIG. 3, the control device 20 includes a data supply unit 26 and a scanning control unit 28. The control device 20 may include a receiver (not shown) that receives a signal supplied from the outside and supplies the signal to the data supply unit 26 and the scanning control unit 28.

The data supply unit 26 includes a frame buffer (not shown) in order to temporarily store the image signals R, G, and B. The data supply unit 26 supplies one frame's worth of video image signal (or in other words, one frame image) received from the outside to the source driving circuit 16, and stores the video image signal in the frame buffer. The stored video image signal may be supplied to the source driving circuit 16 at a predetermined timing (for example, in a row-sequential manner). The data supply unit 26 is an example of a video image signal supply unit.

The scanning control unit 28 is a control unit that controls the timing at which the video image signals R, G, and B are displayed on the panel unit 12. The scanning control unit 28 receives, from the outside, a vertical synchronization signal VS, a horizontal synchronization signal HS, and a video image period signal DE, and outputs the received signals to the gate driving circuit 14 and the source driving circuit 16. In particular, the scanning control unit 28 supplies a start signal START, a clock signal CLK, and a clear signal CLR to the gate driving circuit 14, the start signal START being a signal that is used by the gate driving circuit 14 so as to generate per-row control signals WS1, WS2, WS3, . . . , and WSN.

As shown in FIG. 4, the gate driving circuit 14 includes a clear terminal for receiving the clear signal CLR, a start terminal for receiving the start signal START, and a shift register 140 in which a plurality of registers 141 to 144 provided corresponding to the rows of the panel unit 12 are connected in multiple stages.

A first-stage register 141 acquires the start signal START from the start terminal in synchronization with the clock signal CLK, and second and subsequent-stage registers 142 to 144 acquires the start signal START from their preceding register in synchronization with the clock signal CLK. In this way, the shift register 140 outputs per-row control signals WS1 to WSN while transferring the start signal START between the registers 141 to 144.

The start signal START in the second and subsequent-stage registers 142 to 144 is cleared according to the clear signal CLR. To be specific, when the clear signal CLR is at a high level, the start signal START is blocked (or in other words, fixed at a low level) by an interstage AND circuit. For this reason, the start signal START is cleared to a low level in the registers 142 to 144 by supplying the clock signal CLK while the clear signal CLR is set at a high level.

### 4. Operations of Control Device and Gate Driving Circuit

Operations performed by the control device 20 and the gate driving circuit 14 according to the present embodiment will now be described.

The display device 1 according to the present embodiment is driven by, for example, a progressive driving scheme for organic EL light emitting panels, and displays a video image composed of a plurality of frame images having a variable frame rate. To be more specific, the control device 20 performs control so as to cause the panel unit 12 in which a plurality of pixel circuits 30 are arranged in rows and columns to perform a refresh operation. That is, under control of the control device 20, a write operation of writing the video image signal is sequentially performed from the first row to the last row in the panel unit 12. This period will be referred to as a “frame period”. The frame period may vary from frame to frame.

Hereinafter, the refresh operation performed in the display device 1 will be described in detail.

FIG. 5 is a timing chart illustrating examples of operations performed in the display device 1. In FIG. 5, the region marked with A shows a refresh operation of writing a video image signal that corresponds to one frame image into the pixel circuits 30 of all rows of the panel unit 12.

At the beginning of a frame period, the control device 20 sets the start signal START to a high level for one clock period when starting the supply of a video image signal corresponding to the frame image to the display panel 10. The gate driving circuit 14 outputs the start signal START as per-row control signals WS1 to WSN in a row-sequential manner while transferring the start signal START in synchronization with the clock signal CLK. In synchronization with this, the control device 20 supplies a per-row video image signal to the source driving circuit 16 (not shown).

In this way, the video image signal is written into all pixel circuits 30, and a frame image is displayed on the panel unit 12. The refresh operation shown in the region marked with A in FIG. 5 is an ordinary refresh operation.

In FIG. 5, the region marked with B shows a refresh interruption operation that is characteristic of the refresh operation of the display device 1.

When the subsequent frame image is ready for use during refresh in the preceding frame image, the control device 20 sets the clear signal CLR to a high level. As used herein, the expression “the subsequent frame image is ready for use” means that, for example, the supply of the subsequent frame image from the GPU is started, and the control device 20 may detect, for example, based on the vertical synchronization signal VS, that the subsequent frame image is ready for use. The gate driving circuit 14 blocks the transfer of the start signal START to the second and subsequent-stage registers according to the clear signal CLR that has been set to a high level, so as to interrupt the supply of the control signal WS (the control signals WS3 to WSN shown in FIG. 5) to the pixel circuits in the subsequent rows.

Through this, the refresh operation that is being executed is interrupted, and the panel is ready to start refreshing the subsequent frame image. Here, the clear signal CLR is an example of the refresh interruption signal.

### 5. Advantageous Effects, Etc.

With the display device 1 according to the present embodiment, the following advantageous effects can be obtained by using the refresh interruption operation.

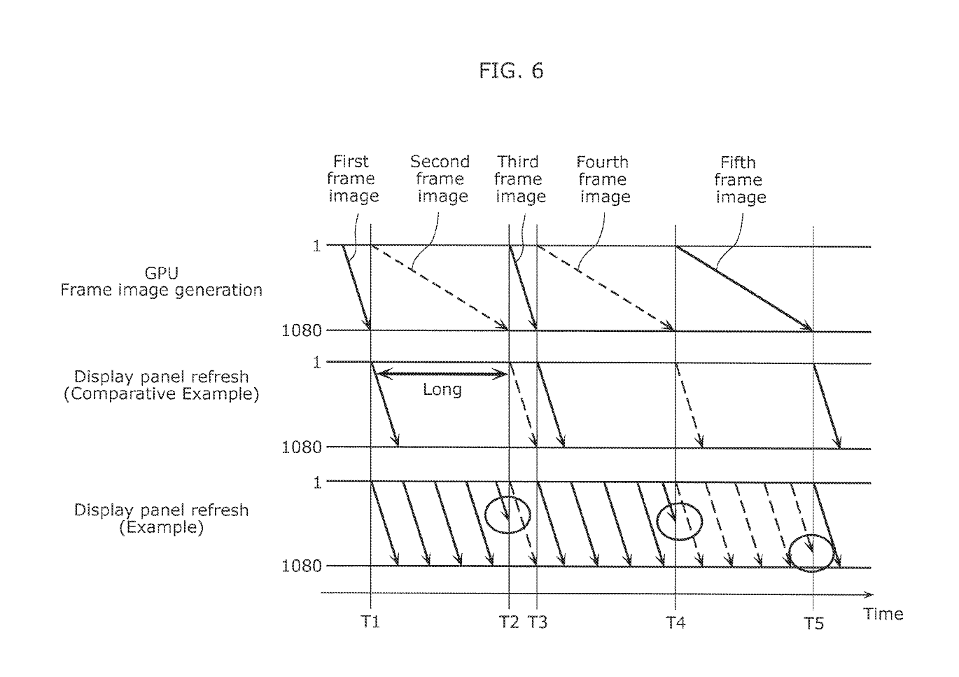

FIG. 6 is a timing chart illustrating the advantageous effects of the display device 1 according to the present embodiment. In FIG. 6, the upper, middle, and lower regions respectively show execution timings of a frame image generation operation performed by the GPU, a refresh operation performed on the display panel according to a comparative example, and a refresh operation performed on the display panel according to an example of the present embodiment. In FIG. 6, solid lines and broken lines are alternately assigned to the frames so as to distinctively show the operation timings of the frames.

At time T1, the GPU finishes generating a first frame image, and thus the first frame image is ready for use. After time T1, the display panel 10 performs a refresh operation of writing a per-pixel video image signal of the first frame image to the pixel circuits 30. The first refresh operation is also performed in the comparative example and the example of the present embodiment.

At time T1, the GPU starts generating a second frame image. Here, it is assumed that it takes time longer than one refresh period to generate the second frame image.

A refresh operation according to the comparative example is performed only once on the first frame image, and thereafter the refresh operation is suspended to time T2 at which a subsequent second frame image is ready for use. For example, in a conventional technique in which a long vertical blank period is provided in the case where the refresh rate is low, it is considered that the refresh operation is simply suspended until a subsequent frame image is ready for use as in the comparative example given here. If it takes a long time to generate a subsequent frame image, there is a concern that the refresh suspension time is prolonged, which may cause video image signal volatilization within the pixel circuits, and also cause degradation in grayscale representation and flickering.

In contrast, in the refresh operation according to the example of the present embodiment, a refresh is repeatedly performed in the first frame image until time T2 at which a subsequent second frame image is ready for use. In second and subsequent instances of refresh in the first frame image, the video image signal of the first frame image stored in the data supply unit 26 of the control device 20 is supplied to the display panel 10.

At time T2, the GPU finishes generating a second frame image, and thus the second frame image is ready for use. At this time, in the comparative example, because the refresh operation is suspended, it is possible to immediately start a refresh in the second frame image, whereas in the example of the present embodiment, the second and subsequent instances of refresh may be being executed in the first frame image.

Here, if a refresh is started on the second frame image without interrupting the refresh in the first frame image, or in other words, without clearing the control signals WS for refreshing the first frame image, the control signals WS overlap, and a wrong video image signal is written into the pixel circuits.

Accordingly, in the example of the present embodiment, the refresh performed on the first frame image is interrupted by using the clear signal CLR (see a circle at T2 in FIG. 6). By doing so, in the example of the present embodiment as well, it is possible to immediately start a refresh in the second frame image, without waiting until the refresh that is being executed in the first frame image ends.

At time T3, the GPU finishes generating a third frame image, and thus the third frame image is ready for use. It is assumed here that the third frame image is generated within one refresh period. In both the comparative example and the example of the present embodiment, a refresh in the third frame image is started immediately after the end of the refresh performed in the second frame image.

It is assumed here that it takes time longer than one refresh period to generate subsequent fourth and fifth frame images, as with the second frame image. In the same manner as described above, in the comparative example, the refresh operation is suspended until the fourth frame image and the fifth frame image are ready for use. In contrast, in the example of the present embodiment, a refresh is repeatedly performed in the third frame image and the fourth frame image until the fourth frame image and the fifth frame image are ready for use. Then, when the fourth frame image and the fifth frame image become ready for use, the refresh operation of the preceding frame image is interrupted by using the clear signal CLR (see circles at T4 and T5 in FIG. 6), and a refresh is started in a new frame image.

As described above, with the refresh operation according to the comparative example, because a refresh is performed only once on one frame image, there is a concern that if it takes a long time to generate a subsequent frame image, the video image signal may volatilize within the pixel circuits, and degradation in grayscale representation and flickering may occur.

In contrast, in the refresh operation according to the example of the present embodiment, a refresh is repeatedly performed in a preceding frame image until a subsequent frame image is ready for use, and thus video image signal volatilization does not occur within the pixel circuits, and the occurrence of degradation in grayscale representation and flickering is suppressed. In the example of the present embodiment, the refresh repetition operation may be performed at a minimum frequency that the degree of video image signal volatilization within the pixel circuits is within an acceptable range, according to the required video image quality.

Also, in the example of the present embodiment as well as the comparative example, a refresh in the subsequent frame image is started from the first pixel circuit immediately when the subsequent frame image becomes ready for use, and thus tearing and stuttering, which were described in the background section in this specification, do not occur.

As described above, with the display device 1 according to the present embodiment, a clear terminal for receiving a clear signal CLR that serves as the refresh interruption signal is provided on the gate driving circuit 14 such that a preceding control signal WS can be cleared by using the clear signal CLR. For this reason, with the display device 1, a refresh in the subsequent frame image can be started by interrupting a refresh performed in a preceding frame image immediately when the subsequent frame image becomes ready for use, while repeatedly refreshing the preceding frame image.

With this configuration, it is possible to obtain a display device, with which it is possible to avoid video image tearing and stuttering, as well as suppressing degradation in grayscale representation and flickering.

In the display device 1, as an example, the clear signal CLR has been described as a signal that functions as the refresh interruption signal, but the refresh interruption signal is not limited to the clear signal CLR. For example, the start signal START may function as the refresh interruption signal. Hereinafter, a display device will be described in which the start signal START functions as the refresh interruption signal.

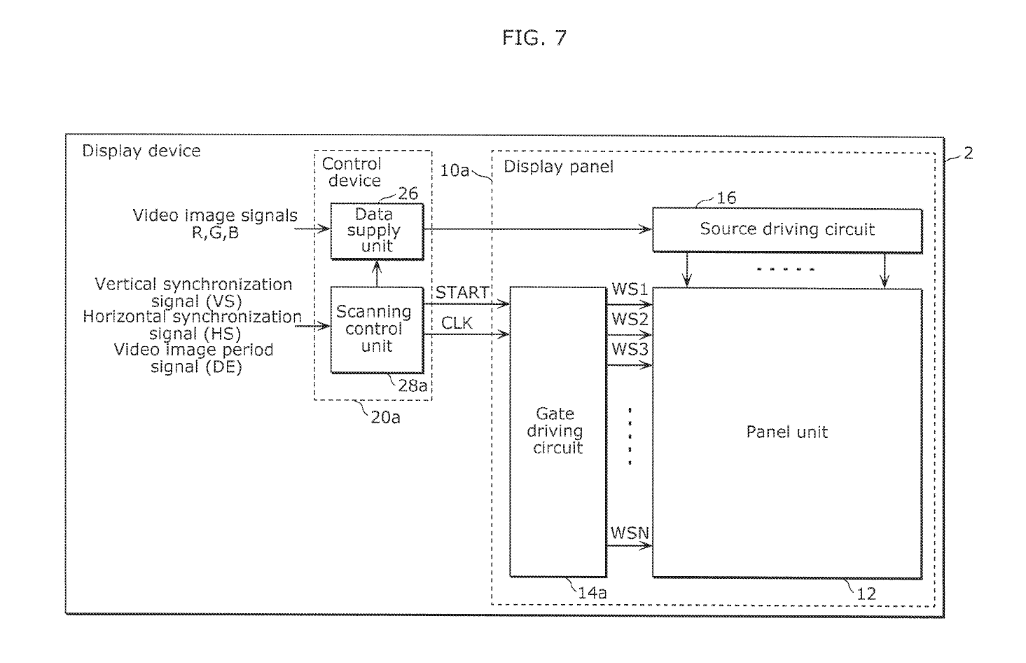

FIG. 7 is a block diagram showing an example of a configuration of a display device 2 according to the present embodiment. The display device 2 shown in FIG. 7 is different from the display device 1 shown in FIG. 3 in that the clear signal CLR is omitted, and a scanning control unit 28a provided in a control device 20a and a gate driving circuit 14a provided in a display panel 10a are different.

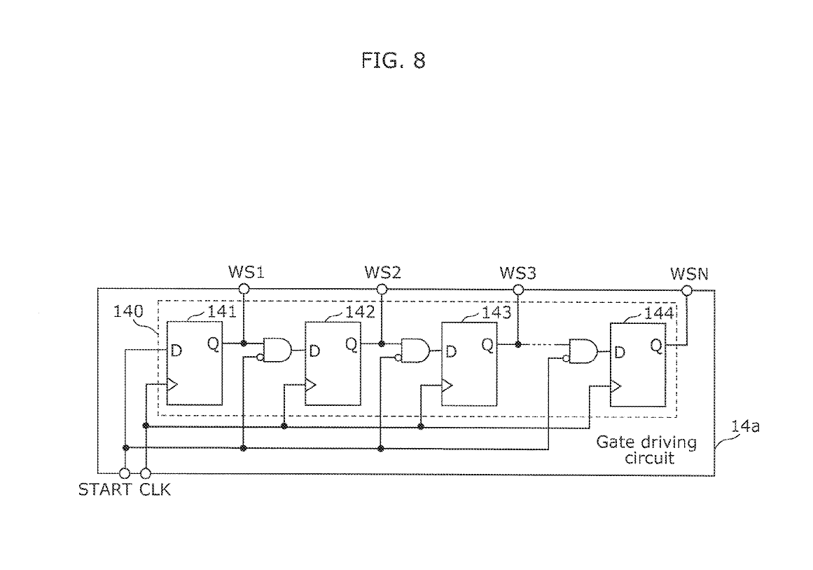

FIG. 8 is a circuit diagram showing an example of a configuration of the gate driving circuit 14a according to the present embodiment. The gate driving circuit 14a shown in FIG. 8 is different from the gate driving circuit 14 shown in FIG. 4 in that the transfer of a preceding start signal START to the second and subsequent-stage registers 142 to 144 is blocked according to a subsequent start signal START acquired by the first-stage register 141.

Accordingly, in the gate driving circuit 14a, the clock signal CLK is supplied while the start signal START is set at a high level, and thereby the subsequent start signal START is stored in the first-stage register 141, and at the same time, the preceding start signal START is cleared to a low level in the registers 142 to 144.

Hereinafter, a refresh operation performed in the display device 2 will be described in detail.

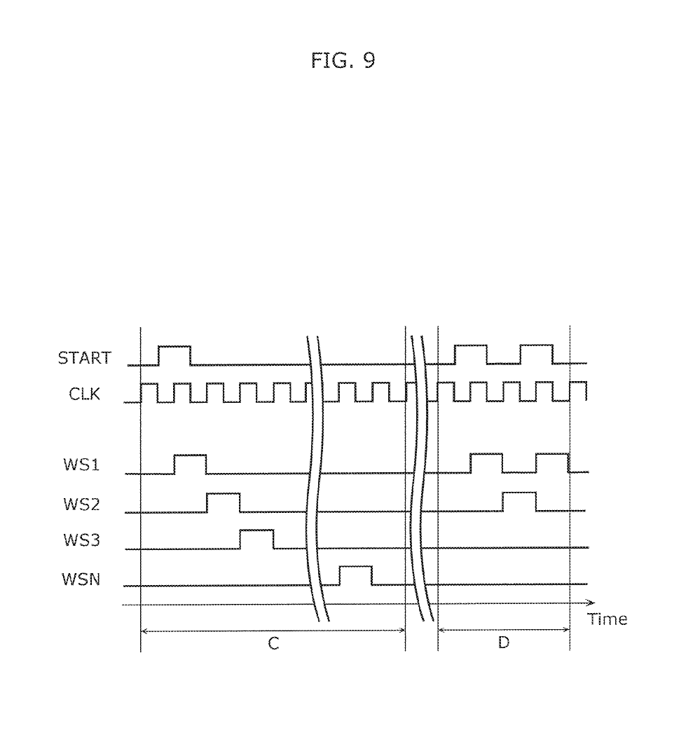

FIG. 9 is a timing chart illustrating examples of operations performed in the display device 2.

In FIG. 9, the region marked with C shows an ordinary refresh operation that is substantially the same as that shown in the region marked with A shown in FIG. 5.

In FIG. 9, the region marked with D shows a refresh interruption operation that is characteristic of the refresh operation of the display device 2. The operation shown in the region marked with D in FIG. 9 is different from the operation shown in the region marked with B in FIG. 5 in that in response to the start signal START, the preceding refresh is interrupted, and at the same time, the subsequent refresh is started.

When the subsequent frame image becomes ready for use during refresh in the preceding frame image, the control device 20a sets the start signal START to a high level. In response to the start signal START being set to a high level, the gate driving circuit 14a blocks the transfer of the preceding start signal START to the second and subsequent-stage registers, and interrupts the supply of the control signal WS (the control signals WS3 to WSN shown in FIG. 9) to the pixel circuits in the subsequent rows.

By doing so, the refresh that is being executed is interrupted, and a refresh in the subsequent frame image is started. Here, the start signal START functions both as a refresh interruption signal for interrupting the preceding refresh, and a refresh start signal for stating a subsequent refresh.

With the display device 2 according to the present embodiment as well, by using the refresh interruption operation, as with the display device 1 described above, it is possible to obtain a display device, with which it is possible to avoid video image tearing and stuttering, as well as suppressing degradation in grayscale representation and flickering.

### Pixel Circuit According to Variation 1

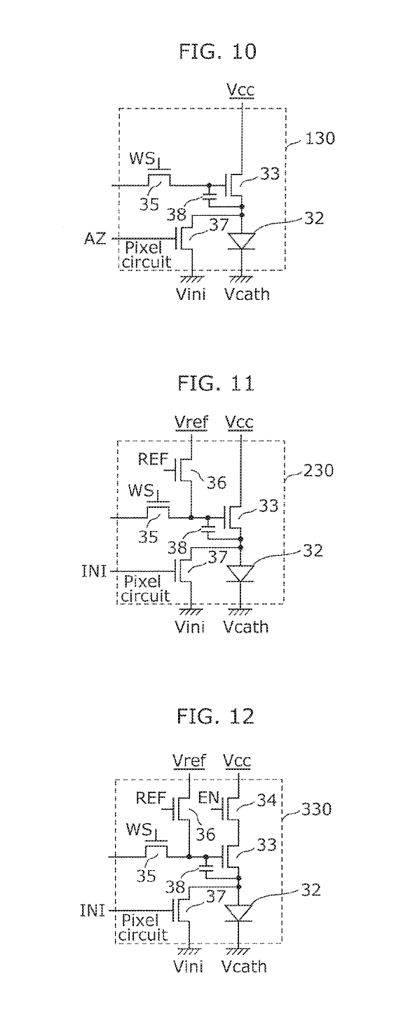

FIG. 10 is a circuit diagram showing an example of a configuration of a pixel circuit 130 according to Variation 1. The pixel circuit 130 according to the present variation is different from the pixel circuit 30 according to the embodiment in that the pixel circuit 130 according to the present variation includes a switch transistor 37.

As shown in FIG. 10, the pixel circuit 130 includes a light emitting element 32, a driving transistor 33, a selection transistor 35, a switch transistor 37, and a pixel capacitor 38.

The switch transistor 37 is turned on according to a control signal AZ, and sets the source of the driving transistor 33 to a reference voltage Vini. The light emitting element 32, the driving transistor 33, the selection transistor 35, and the pixel capacitor 38 have the same configurations as those of the light emitting element 32, the driving transistor 33, the selection transistor 35, and the pixel capacitor 38 of the pixel circuit 30 according to the embodiment.

Even with a display panel that includes the pixel circuits 130 configured as described above, as with the display device 1 according to the embodiment, by performing the characteristic refresh operation, it is possible to avoid video image tearing and stuttering, as well as suppressing degradation in grayscale representation and flickering.

### Pixel Circuit According to Variation 2

FIG. 11 is a circuit diagram showing an example of a configuration of a pixel circuit 230 according to Variation 2. The pixel circuit 230 according to the present variation is different from the pixel circuit 130 according to Variation 1 in that the pixel circuit 230 according to the present variation includes a switch transistor 36.

As shown in FIG. 11, the pixel circuit 230 includes a light emitting element 32, a driving transistor 33, a selection transistor 35, switch transistors 36 and 37, and a pixel capacitor 38.

The switch transistor 36 is turned on according to a control signal REF, and sets the gate of the driving transistor 33 to a reference voltage Vref. The light emitting element 32, the driving transistor 33, the selection transistor 35, the switch transistor 37, and the pixel capacitor 38 have the same configurations as those of the light emitting element 32, the driving transistor 33, the selection transistor 35, the switch transistor 37, and the pixel capacitor 38 of the pixel circuit 130 according to Variation 1.

Even with a display panel that includes the pixel circuits 230 configured as described above, as with the display device 1 according to the embodiment, by performing the characteristic refresh operation, it is possible to avoid video image tearing and stuttering, as well as suppressing degradation in grayscale representation and flickering.

### Pixel Circuit According to Variation 3

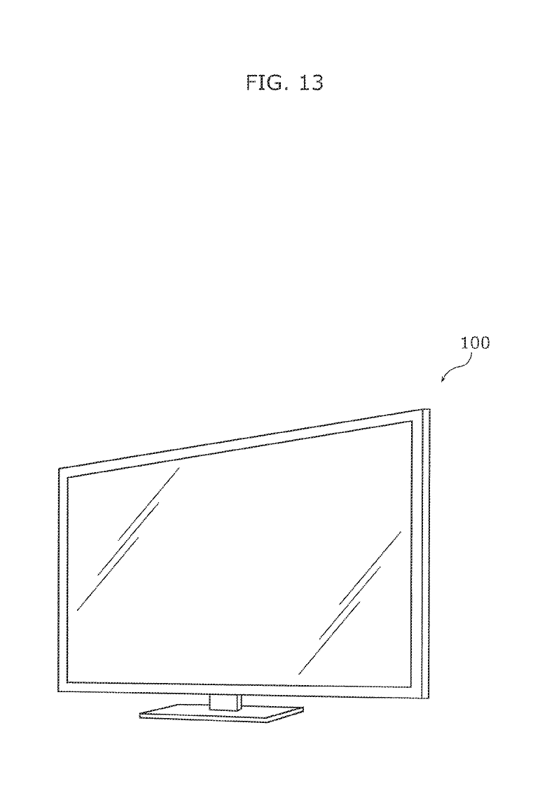

FIG. 12 is a circuit diagram showing an example of a configuration of a pixel circuit 330 according to Variation 3. The pixel circuit 330 according to the present variation is different from the pixel circuit 230 according to Variation 2 in that the pixel circuit 330 according to the present variation includes a switch transistor 34.

The switch transistor 34 is turned on or off according to a light extinction signal EN supplied from the scanning line 40. In response to being turned on, the switch transistor 34 connects the driving transistor 33 to a power supply Vcc, and supplies the drain-to-source current of the driving transistor 33 to the light emitting element 32. The light emitting element 32, the driving transistor 33, the selection transistor 35, the switch transistors 36 and 37, and the pixel capacitor 38 have the same configurations as those of the light emitting element 32, the driving transistor 33, the selection transistor 35, the switch transistors 36 and 37, and the pixel capacitor 38 of the pixel circuit 230 according to Variation 2.

Even with a display panel that includes the pixel circuits 330 configured as described above, as with the display device 1 according to the embodiment, by performing the characteristic refresh operation, it is possible to avoid video image tearing and stuttering, as well as suppressing degradation in grayscale representation and flickering.

### Other Embodiments

The present disclosure is not limited to the configurations described in the embodiments and the variations given above, and it is possible to make modifications as appropriate.

For example, the gate driving circuit may be provided on one of the short sides of the panel unit, or may be provided on each of the opposing short sides of the panel unit. Likewise, the source driving circuit may be provided on one of the long sides of the panel unit, or may be provided on each of the opposing long sides of the panel unit.

Also, the frame period may be started in the control device 20 based on the supply of a vertical synchronization signal VS, or may be based on the timing at which the input of a video image period signal DE is started.

Also, the data supply unit may include a frame buffer as described above, or may include any other buffer, a storage device, or the like.

Also, the light emitting elements are not limited to organic EL elements, and may be any other light emitting elements such as LEDs.

Also, the light emission and light extinction of a light emitting element may be controlled by using a light extinction signal that provides an instruction for the light emitting element to extinguish light and a light emission signal that provides an instruction for the light emitting element to emit light.

Also, in the display device, the pixel circuit configuration is not limited to those shown in the embodiments and the variations given above, and may be changed. For example, as long as each pixel circuit is configured to include a driving transistor, a selection transistor, and a pixel capacitor, the arrangement of other switch transistors may be changed as appropriate. Also, a plurality of transistors provided in each pixel circuit may be polysilicon TFTs, or other transistors such as amorphous silicon TFTs. Also, the conductivity type of the transistors may be N channel type or P channel type, or may be a combination thereof.

The present disclosure also encompasses other embodiments obtained by making various modifications that can be conceived by a person having ordinary skill in the art to the above-described embodiments without departing from the scope of the present disclosure, as well as embodiments implemented by any combination of the structural elements and the functions of the above embodiments within the scope of the present disclosure. For example, as examples of display devices that include the control device according to the present disclosure, a thin flat television system 100 as shown in FIG. 13, a gaming console in which a display panel is incorporated, and a PC monitor system are also included in the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is useful in technical fields such as, in particular, television systems, and displays for gaming consoles and personal computers that are required to provide display at a high resolution and at a high speed.

1. A display panel comprising:
a panel unit including a plurality of pixel circuits arranged in rows and columns;
a source driving circuit that supplies, to the pixel circuits, a video image signal representing a video image displayed on the panel unit;
a gate driving circuit that supplies a gate signal to the pixel circuits in a row-sequential manner, the gate signal indicating a write timing of writing the video image signal; and
a control terminal that receives a refresh interruption signal,
wherein when the refresh interruption signal is received by the control terminal during the supply of the gate signal, the gate driving circuit interrupts the supply of the gate signal to the pixel circuits in a subsequent row.

2. The display panel according to claim 1,
wherein the gate driving circuit includes:
a clear terminal that receives a clear signal that functions as the refresh interruption signal;
a start terminal that receives a start signal; and
a shift register in which a plurality of registers provided corresponding to the rows of the panel unit are connected in multiple stages,
a first-stage register acquires the start signal from the start terminal,
the shift register outputs the start signal as a per-row gate signal while transferring the start signal between the registers, and
the start signal in second and subsequent-stage registers is cleared according to the clear signal.

3. The display panel according to claim 1,
wherein the gate driving circuit includes:
a start terminal that receives a start signal that functions as the refresh interruption signal; and
a shift register in which a plurality of registers provided corresponding to the rows of the panel unit are connected in multiple stages,
a first-stage register acquires the start signal from the start terminal,
the shift register outputs a per-row gate signal while transferring the start signal between the registers, and
the start signal in second and subsequent-stage registers is cleared according to a new start signal acquired by the first-stage register.

4. A control device for a display panel,
the display panel comprising:
a plurality of pixel circuits that are arranged in rows and columns;
a source driving circuit that supplies a video image signal to the pixel circuits; and
a gate driving circuit that supplies a gate signal indicating a write timing of writing the video image signal to the pixel circuits in a row-sequential manner, and interrupts the supply of the gate signal to the pixel circuits in a subsequent row according to a refresh interruption signal provided during the supply of the gate signal, and
the control device comprising:
a video image signal supply unit that receives a video image signal representing a video image including a plurality of frame images having a variable frame rate, and supplies the video image signal to the display panel; and
a scanning control unit that supplies the refresh interruption signal to the display panel when starting supply of the video image signal that corresponds to a new frame image.

5. A display device comprising: a display panel and a control device,
the display panel including:
a panel unit including a plurality of pixel circuits arranged in rows and columns;
a source driving circuit that supplies, to the pixel circuits, a video image signal representing a video image displayed on the panel unit;
a gate driving circuit that supplies a gate signal to the pixel circuits in a row-sequential manner, the gate signal indicating a write timing of writing the video image signal; and
a control terminal that receives a refresh interruption signal,
wherein when the refresh interruption signal is received by the control terminal during the supply of the gate signal, the gate driving circuit interrupts the supply of the gate signal to the pixel circuits in a subsequent row,
the control device including:
a video image signal supply unit that receives a video image signal representing a video image including a plurality of frame images having a variable frame rate, and supplies the video image signal to the display panel; and
a scanning control unit that supplies the refresh interruption signal to the display panel when starting supply of the video image signal that corresponds to a new frame image.

6. A method for driving a display panel, the method comprising:
supplying a gate signal to a plurality of pixel circuits that are arranged in rows and columns, the gate signal indicating a write timing of writing a video image signal;
receiving a refresh interruption signal during the supplying of the gate signal; and
interrupting the supplying of the gate signal to the pixel circuits in a subsequent row when the refresh interruption signal is received.
